(19) United States
(12) Patent Application Publication
(10) Pub. No.: US 2005/0188075 A1
(43) Pub. Date: Aug. 25, 2005

(54) System and method for supporting transaction and parallel services in a clustered system based on a service level agreement

(75) Inventors: Daniel Manuel Dias, Mohegan Lake, NY (US); Edwin Richie Lassettre, Los Gatos, CA (US); Avraham Leff, Spring Valley, NY (US); Marcos Nogueira Novaes, Hopewell Junction, NY (US); James Thomas Rayfield, Ridgefield, CT (US); Noshir Cavas Wadia, Morgan Hill, CA (US); Peng Ye, Fremont, CA (US)

Correspondence Address: SAMUEL A. KASSATLY LAW OFFICE, 20690 VIEW OAKS WAY, SAN JOSE, CA, 95120, US

(73) Assignee: International Business Machines Corporation, Armonk, NY (US)

(21) Appl. No.: 10/762,916

(22) Filed: Jan. 22, 2004

(51) Int. Cl. G06F 15/173; G06F 15/16

(52) U.S. Cl. 709/224

(57) ABSTRACT

A server allocation controller provides an improved distributed data processing system for facilitating dynamic allocation of computing resources. The server allocation controller supports transaction and parallel services across multiple data centers enabling dynamic allocation of computing resources based on the current workload and service level agreements. The server allocation controller provides a method for dynamic re-partitioning of the workload to handle workload surges. Computing resources are dynamically assigned among transaction and parallel application classes, based on the current and predicted workload. Based on a service level agreement, the server allocation controller monitors and predicts the load on the system. If the current or predicted load cannot be handled with the current system configuration the server allocation controller determines additional resources needed to handle the current or predicted workload. The server cluster is reconfigured to meet the service level agreement.

### FIELD OF THE INVENTION

The present invention generally relates to distributed data processing systems. In particular, it relates to a method for facilitating dynamic allocation of computing resources. More specifically, the present system supports transaction and parallel services across multiple data centers, enabling dynamic allocation of computing resources based on the current workload and service level agreements.

### BACKGROUND OF THE INVENTION

Server-clustered server systems are used to provide scalable Web servers for clients operating transaction applications such as, for example, Web-based stock trading. Conventional server-clustered server systems use a Network Dispatcher/TCP router placed operationally in front of a server cluster of Web server nodes. Server-clustered server systems are also used to support parallel-processing tasks such as numerically intensive computing applications or data mining.

An emerging requirement for server-clustered server systems is concurrent support of transaction and parallel types of applications on server clusters, multiple server clusters, or in grid environments. Web based trading and other applications have highly variable loads; the ratio of peak to average traffic can be very high. Server-clustered server systems are typically configured to handle the peak workload. Consequently, conventional server-clustered server systems are relatively idle much of the time. The conventional server-clustered server system is a very inefficient use of computing resources.

One conventional attempt to more efficiently use computing resources in a server-clustered server system optimizes the assignment of work to a single server-cluster of servers. However, this optimization does not consider the service level agreement for each client. Consequently, this approach may optimize the use of the servers in the server cluster but not meet the service level agreements for one or more clients.

Another conventional attempt to more efficiently using computing resources in a server-clustered server system uses priorities to schedule individual requests to a given set of servers. This approach focuses on scheduling individual requests rather than allocating resources for classes of applications. In addition, this approach does not consider the service level agreements of the clients in allocating resources.

Yet another proposed approach utilizes a mechanism for describing service level agreements. This particular approach describes a method for gathering and sharing the data related to a service level agreement to determine whether the service level agreement is being met. However, this approach does not address actions that may be used to compensate current performance so that service level agreements may be met. In addition, this approach does not provide a means whereby different server clusters may accept workloads from one another.

All of the foregoing conventional approaches are formulated to use computing resources in a server-clustered server system focus on a single server cluster based domain, and do not address the issues involving multiple domains. These conventional methods are based either on reserving resources for specific jobs or ad hoc routing of applications to remote nodes.

What is therefore needed is a method that distributes the available capacity of the server cluster, or more generally a grid, among transaction and parallel applications. Transaction applications are comprised of tasks that are small discrete events such as, for example, stock trading transactions. Parallel tasks are numerically intensive tasks such as, for example, a stock portfolio optimization. This method should provide dynamic sharing of resources across a server cluster such that service level agreements may be met when resources are available. The need for such a solution has heretofore remained unsatisfied.

### SUMMARY OF THE INVENTION

The present invention satisfies the foregoing need, and presents a system, a service, a computer program product, and an associated method (collectively referred to herein as “the system” or “the present system”) for providing an improved distributed data processing system for facilitating dynamic allocation of computing resources. In addition, the present system supports transaction and parallel services across multiple data centers enabling dynamic allocation of computing resources based on the current workload and service level agreements. The present system provides a method for dynamic re-partitioning of the workload to handle workload surges. These workload surges typically occur in the transaction workload.

The present system supports transaction and parallel applications based on service level agreements within a single domain or multiple domains of administration. Specifically, computing resources are dynamically assigned among transaction and parallel application classes, based on the current and predicted workload.

The present system defines a service level agreement for each transaction application and parallel application. Based on the service level agreement, the system monitors the load on the system. Monitoring the system comprises monitoring the transaction rate, the response time, or other metrics as necessary. Optionally, the measured system load for each transaction type is fed to a forecaster or prediction model. This prediction model uses the history and the current load to predict the future load on the system. An analysis component estimates the system utilization and response time based on the current and predicted load.

Based on the service level agreement, the present system determines whether the current or predicted load can be handled with the current system configuration. If the service level agreement is not met, a planning component determines additional resources needed to handle the current or predicted workload. The server cluster is reconfigured to meet the service level agreement.

For example, a surge in the transaction load requires additional servers to support the transaction workload up to the load specified in the service level agreement. The present system may re-capture nodes previously allocated to the parallel workload and reassign them to the transaction workload. Optionally, the present system may configure and setup additional nodes to run the required type of workload. The present system may also configure the routing component to comprise the new node supporting the desired workload.

A principal advantage of the present system is the ability to support both transaction and parallel workloads on the same server cluster. Conventional systems statically assign nodes to either transaction or parallel workloads because the two workloads typically interfere with each other when run on the same system. For example, the parallel application often consumes a lot of memory. Consequently, operating a parallel application on the same nodes as a transaction application, even at a lower priority than the transaction application, causes unacceptable performance degradation of the transaction application.

The present system comprises a service level agreement monitor and an optional prediction model that determines service level agreement violations based on current load or predicted load. The present system also comprises a planning component that determines what changes to the system configuration are needed and an execution component that reconfigures the system to best manage the current or predicted load.

The present clustered system may be embodied in a utility program such as a server allocation utility program, and enables the user to specify a performance parameter for the service level agreement. The clustered system user invokes the service allocation utility expecting the fulfillment of the to reallocate computing resources so as to meet the service level agreement. The performance parameter is made available to the server allocation utility for allocating computing resources to meet the service level agreement for a contracted execution of transaction applications and parallel applications. In response to a violation of the service level agreement, the clustered system server allocation utility dynamically reallocates a computing resource that is assigned to the parallel application, to the transaction application that requires an additional computing resource.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a server allocation controller of the present invention can be used;

FIG. 2 is a block diagram of the high-level architecture of the server allocation controller of FIG. 1; and

FIG. 3 is comprised of FIGS. 3A and 3B, and represents a process flow chart illustrating a method of operation of the server allocation controller of FIGS. 1 and 2.

### DETAILED DESCRIPTION OF PREFERRED EMBODIMENTS

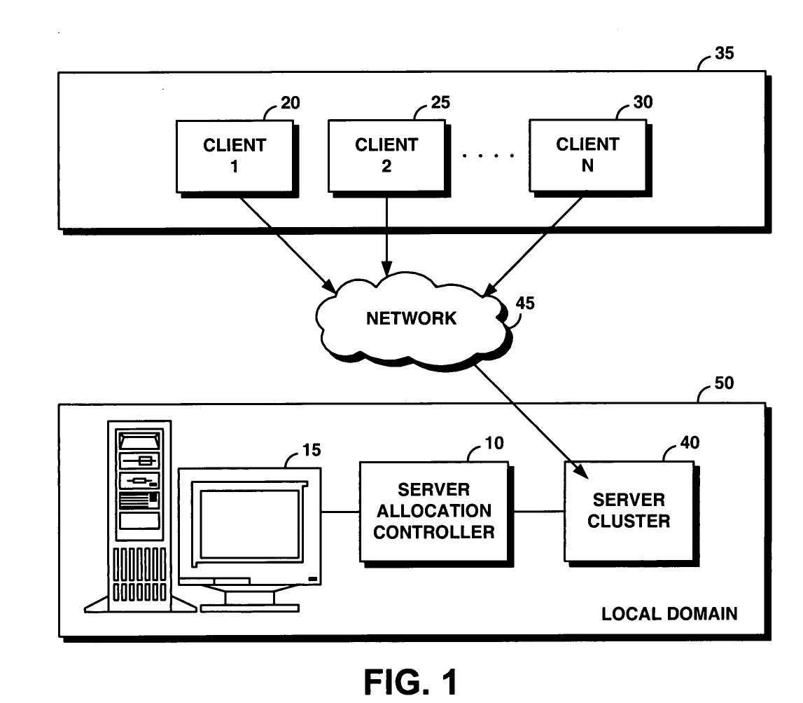

FIG. 1 portrays an exemplary overall environment in which a system and associated method for supporting transaction and parallel services in clustered systems based on service level agreements according to the present invention may be used. A server allocation controller 10 comprises a software programming code or a computer program product that is typically embedded within, or installed on a server 15. Alternatively, the server allocation controller 10 can be saved on a suitable storage medium such as a diskette, a CD, a hard drive, or like devices.

Clients, such as client 1, 20, client 2, 25, client 3, 30, are collectively referenced as clients 35, and access a server cluster 40 via a network 45. Server 15 defines and supports a set of service level agreements corresponding to a mixture of transaction and parallel services running on the server cluster 40. Clients 35 invoke these services by making requests to the server cluster 40 through network 45.

The server cluster 40 supports a set of workloads that represent requests from different clients 35 and workload types, each with service level agreements. For example, the server cluster 40 may have a transaction workload type as well as a parallel workload type. A local domain 50 comprises the server cluster 40, server 15, and the server allocation controller 10.

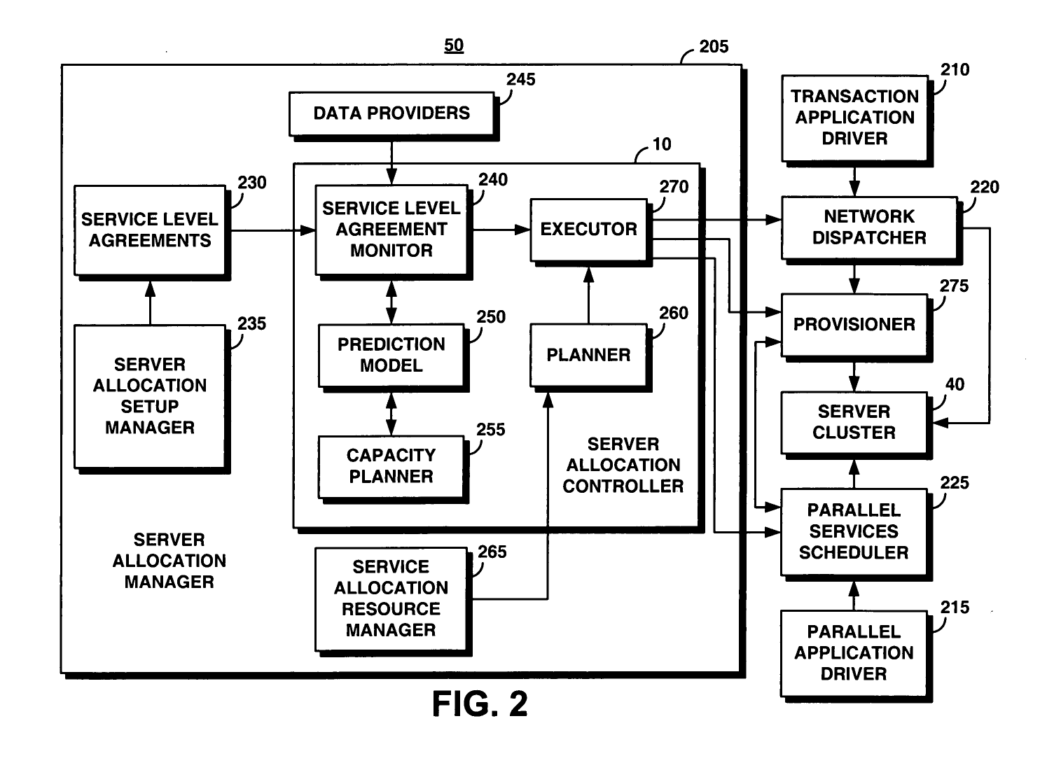

A high-level hierarchy of the server allocation controller 10 is illustrated by the diagram of FIG. 2. A server allocation manager 205 comprises the server allocation controller 10. For exemplary purposes, workloads for the server cluster 40 are a transaction application driver 210 and a parallel application driver 215.

The server allocation manager 205 may manage additional workloads not shown. Some of these additional workloads may be transaction applications and some may be parallel applications. Parallel applications are typically numerically and processing intensive, requiring large amounts of memory. An example of a parallel application is a stock portfolio optimization.

Transaction applications are typically events such as stock transactions that are not processing intensive. The transactional application as whole may be spread over a number of servers. Each individual transaction typically runs on one server. The stock trading application has multiple transactions from different clients 35 that can run concurrently on different servers accessing the same database.

Each application type has a dispatcher or scheduler used to route requests to one or more servers (also referred to as nodes) in the server cluster 40. The server allocation manager 205 assigns nodes to the transaction applications or the parallel applications. A node may not be shared by the transaction applications or the parallel applications because they interfere with each other.

For example, the transaction application requests from the transaction application driver 210 may be routed to nodes in the server cluster 40 by a network dispatcher 220. Similarly, the parallel workload from the parallel application driver 215 may be scheduled on servers in the server cluster 40 by a parallel services scheduler 225.

Service level agreements 230 are defined for each workload. Optionally, the service level agreements 230 may be defined for a subset of the workloads. The service level agreements 230 are negotiated with each of the clients 35 and implemented by a server allocation setup manager 235.

The server allocation manager 205 assigns nodes to various workloads based on the service level agreements 230. The service level agreements 230 specify performance elements to be provided by the server cluster 40 to clients 35. These performance elements comprise the throughput for each application that is supported and, optionally, the response time for the specified throughput.

The service level agreements 230 may comprise various other clauses, conditions and rules, such as availability or downtime. The service level agreements 230 may also comprise different classes of workloads within an application and the service level agreements 230 for these different classes of workloads. In addition, the service level agreements 230 may comprise penalty functions if the clauses in the service level agreements 230 are violated, etc. Typically the server allocation manager 205 manages many service level agreements 230 at any one time.

A service level agreement monitor 240 is dynamically configured to monitor the workload and system elements to determine whether the service level agreements 230 are being satisfied. The service level agreement monitor 240 is given information about each of its set of workloads through one or more data providers 245. The data providers 245 give information about the current state of the workloads with respect to conditions of interest to one or more of the service level agreements 230. Parameters monitored by the service level agreement monitor 240 may comprise the transaction rate, transaction response time, availability, server cluster node utilization, etc. If the service level agreements 230 are not being met, the service level agreement monitor 240 flags a violation event.

A set of nodes in the server cluster 40 is assigned to each workload; this assignment is typically based on the average load on the server cluster 40. The service level agreement monitor 240 determines if the service level agreements 230 are being met for the current workload and nodes assigned to the corresponding workloads. Optionally, the service level agreement monitor 240 passes the monitored information to a prediction model 250. The prediction model 250 projects into the future the estimated workload such as throughput. Forecasting by the prediction model 250 may be short term (i.e., seconds, minutes, or hours) or long term.

The prediction model 250 also estimates the response time, system utilization or other measure based on the predicted workload. Based on the output of the prediction model 250, the service level agreement monitor 240 may optionally determine if projections indicate that the service level agreements 230 may not be met.

In one embodiment, higher and lower utilization or throughput levels are set, and a node is added or subtracted if the threshold is crossed. The problem is that (i) the thresholds are static, and (ii) if the load crosses the threshold for a short period of time, oscillation can result. According to the present invention, in one dimension, the threshold varies by the number of nodes allocated to a particular transactional workload.

The reason is that, when a node is added, going from one to two nodes, the utilization or throughput per node is halved. As a result, when two nodes are allocated to a workload, going up from one, the lower threshold must be less than one half of the upper threshold that was allocated for one node.

If the upper threshold for k nodes allocated is t_upper(k) and the lower threshold for k+1 nodes is t_lower(k+1), then:
t_{—}lower(k+1)*(k+1)<t_{—}upper(k)*k.

One method is to set t_lower(k+1)=t_upper(k)*f*k/(k+1), where f<1, for example f=0.8 would allow a 20% variation reduction in the load without decreasing the number of nodes. If the lower threshold is not reduced with increase in the number of nodes, then the allocation of nodes becomes excessive for large clusters.

On the other hand, as t_lower is increased, the probability of oscillation grows. The fraction f can be adjusted dynamically, depending on the degree of normal variation in the load over a period of time t_measure, where t_measure depends on how quickly a node can be added or subtracted, and the impact on the system caused by this change. For example, if it takes 5 minutes to allocate a new node and cache required data, then the ratio of the minimum to the maximum load in 5-minute intervals can be used to set f.

To minimize the oscillation, the time below t_lower(k) is increased, i.e., the load must fall below the lower threshold for a period of time t_hold, before action is taken to reduce the number of nodes. If the load again increases above t_lower(k) within the t_hold time period, the count is reset, so that the load must fall below t_lower(k) for t_hold again.

The time t_hold can be adjusted dynamically, so that t_hold is increased if large variations in load that would cause oscillation are observed. Since a short spike in (increased) load can cause the t_upper(k) to also be exceeded, a different t_hold_upper and t_hold_lower can be set. Typically:
t_hold_upper <=t_hold_lower
because the effect of overload can be more detrimental than underload.

Performance predictions of the prediction model 250 may optionally be sent to a capacity planner 255. The capacity planner 255 determines the server capacity required of the server cluster 40 based on the predictions of the prediction model 250.

Performance predictions of the prediction model 250 are also sent to the service level agreement monitor 240. The service level agreement monitor 240 determines whether the local domain 50 may miss a service level in the future, based on the predicted value. The service level agreement monitor 240 obtains current performance values and optional predicted values and can flag violations of the service level agreements 230 based on either current or future predictions.

Given a current or predicted violation of any of the service level agreements 230, a planner 260 determines a response to the violation. This response is a plan for allocating the servers in the server cluster 40 to the transaction and parallel requests to minimize cost to the local domain 50. Planner 260 can decide to meet all the service level agreements 230. Otherwise, planner 260 adjusts the workload for each of the servers in the server cluster 40 based on one or more policies.

A policy implemented by planner 260 may adjust the workloads based on priority. Planner 260 may specify that a certain transaction class is more important than another. In an embodiment, a minimum and maximum number of servers are allocated to each workload so other workloads are neither “starved” nor does any one workload receive all the resources of the server cluster 40.

Planner 260 obtains information on the current assignments of the servers in the server cluster 40 from a server allocation resource manager 265. This information may comprise priorities, allocations, etc. Planner 260 then determines a server reallocation plan to best minimize costs of the local domain 50. For example, planner 260 may decide to violate the service level agreements 230 for one workload in favor of not violating the service level agreements 230 for another workload. Planner 260 may decide to violate the service level agreements 230 for an important workload to accommodate the additional processing required for a spike in stock trades that occurs after the chairman of the Federal Reserve Board makes a speech.

The reallocation plan created by planner 260 is sent to an executor 270. This reallocation plan may comprise information on server allocations and allocation of specific loads to specific servers in server cluster 40. Executor 270 reconfigures the server cluster 40 as directed by planner 260. Executor 270 calls provisioner 275 if one or more servers require provisioning.

For example, planner 260 may determine that one additional server may be allocated to the stock trading transaction workload and one server may be removed from the parallel application workload. Provisioner 275 informs the parallel services scheduler 225 to stop using a specific server, server A. The parallel services scheduler 225 informs provisioner 275 when it releases server A. Executor 270 may then call provisioner 275 and request that server A be assigned to the stock trading transaction workload. Provisioner 275 then installs the stock trading application on server A. Executor 270 then informs the network dispatcher 220 of the change in server configuration, allowing the network dispatcher 220 to use server A.

In another embodiment, the server allocation controller 10 may add one node at a time to the workload. If the service level agreements 230 are not met with the additional node, the server allocation controller 10 may assign additional nodes to a workload, one at a time, until the service level agreements 230 are met. In a further embodiment, the server allocation controller 10 may add nodes to a workload, one at a time, if the prediction model 250 predicts that the server cluster 40 may not meet the service level agreements 230.

The service level agreement monitor 240 may determine that the service level agreements 230 for one or more other workloads on the server cluster 40 can be met with fewer nodes. If so, executor 270 reconfigures the network dispatcher 220 or the parallel services scheduler 225 for that workload; this reconfiguration stops dispatching to a specific node or set of nodes. Executor 270 uses the computed plan from planner 260 to reconfigure the server cluster 40 to handle the current or predicted load. Concurrently, the network dispatcher 220 or parallel services scheduler 225 for the workload projected to need additional nodes is reconfigured to add that specific node or set of nodes.

The service level agreement monitor 240 may determine that fewer nodes cannot meet the service level agreements 230 for other workloads. In this case, additional nodes cannot be assigned to the workload needing additional nodes from any of the other workload. In an embodiment, the server allocation controller 10 may request or configure new nodes. The server allocation controller 10 then assigns these new nodes to the workload that needs the additional nodes.

If additional nodes are not available to meet all the service level agreements 230 for the current or projected workload, the server allocation controller 10 uses an internal policy to determine priorities for service level agreements 230 that may be violated. For example, this prioritization may be performed based on minimizing the penalty associated with violating service level agreements 230. The server allocation controller 10 then removes nodes from the workload with lower penalty or lower priority and assigns these nodes to the workload with higher penalty or higher priority.

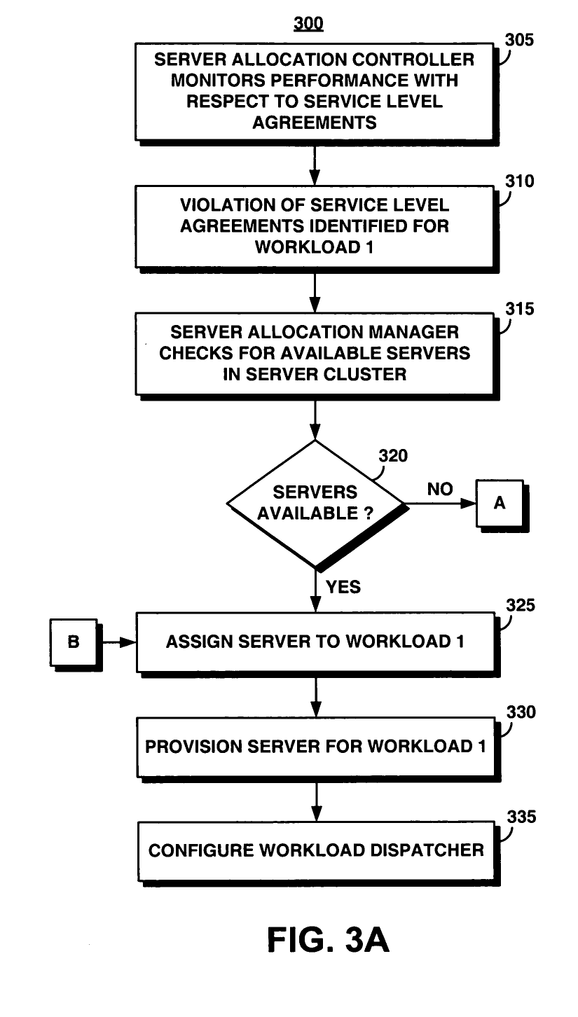

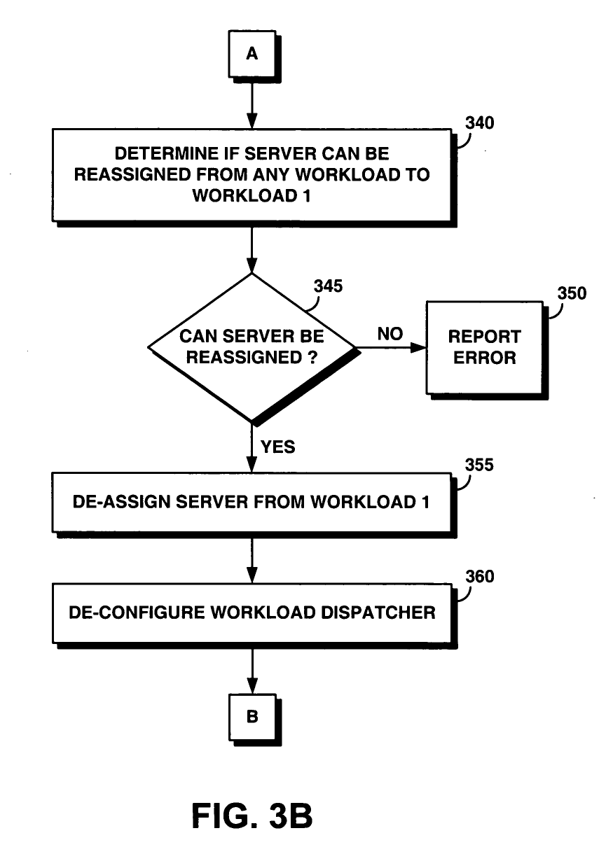

A method 300 for managing server allocations to minimize penalties and maximize system performance is illustrated by the process flow chart of FIG. 3 (FIGS. 3A, 3B). The server allocation controller 10 monitors performance with respect to the service level agreements 230 at step 305. The service level agreement monitor 240 identifies a violation of the service level agreement 230 for a workload, workload 1, at step 310. This violation may be a current violation or a predicted violation. The server allocation manager 205 checks for available servers in the server cluster 40 at step 315 that may be allocated to workload 1.

If at decision step 320 additional servers are available in the server cluster 40, executor 270 assigns those available servers to workload 1 at step 325. Provisioner 275 optionally provisions the available server for workload 1 at step 330; the available server may already be provisioned for workload 1. Executor 270 configures the appropriate workload dispatcher at step 335 to enable dispatching workload 1 to the available server.

If the server allocation manager 205 determines at decision step 320 that no additional servers are available, a server may be reallocated to workload 1 from some other workload, for example, workload 2. The server allocation manager 205 determines within the policy of the local domain 50 whether a server can be allocated from any workload to workload 1 at step 340 (FIG. 3B). Reassignment determinations comprise consulting with the current allocation, reviewing the policy in terms of workload parity, and deciding whether a server can be reassigned from some other workload. If at decision step 345 a server cannot be reassigned, the server allocation manager 205 reports an error at step 350. At this point, a violation of the service level agreements 230 can neither be avoided nor mitigated within the policy of the local domain 50.

If at decision step 345 a server can be reassigned, executor 270 de-assigns a server at step 355 from workload 2, for example. At step 360, executor 270 de-configures the appropriate workload dispatcher of the server that is being de-assigned. Method 300 then proceeds with steps 325, 330, 335 in assigning the newly available server from step 355 to workload 1.

In an embodiment, a minimum number of nodes in the server cluster 40 may be assigned to each workload, with the remainder in a shared pool of nodes. For example, the nodes in the server cluster 40 may support a transactional workload and a parallel application. An exemplary policy may assign a minimum number of nodes to each workload, e.g. one node minimum to each workload. The remaining nodes are in a shared pool of nodes that may be assigned to either workload. Any one node may not be assigned to both workloads at the same time.

An exemplary policy for managing the shared pool may provide priority to the transaction workload, provided the maximum throughput defined by the service level agreements 230 are not exceeded. Method 300 is then used to dynamically allocate nodes in the shared pool to one of the workloads based on the current and predicted load, and the service level agreements 230.

In another embodiment, servers in the server cluster 40 comprise several categories. Servers may be workload nodes that are currently serving a specific workload type. Alternatively, servers may be provisioned nodes that are provisioned to accept requests from a particular workload class but are currently not serving that workload. However, the workload balancer for that workload is configured to not route workload from that class to the provisioned node. Servers may be uninitialized nodes that have the application and its prerequisites installed (e.g. Linux, DB2, WebSphere, application), but not initialized, so as not to consume any computing resources. Further, servers may be uninstalled nodes that do not have that application and its prerequisites installed.

The server allocation controller 10 allocates and assigns a number of nodes in each category, based on forecasting and prediction of workloads in each class. Workload nodes assigned are based on current load. Provisioned nodes are assigned based on the expected fluctuation in load or predicted load in a time frame less than that for starting up the middleware and application. Uninitialized nodes are assigned assuming the expected fluctuation in load will occur in a time frame less than the time to provision and set up the operating system, middleware, and application.

A further embodiment of the server allocation controller 10 supports the service level agreements 230 for multiple transaction workloads. Penalties are assigned for not supporting the service level agreements 230 at various levels. When all the service level agreements 230 cannot be met, resources are allocated based on optimizing performance while minimizing the aggregate penalty function. This embodiment utilizes the prediction model 250 and the capacity planner 255 to base the server allocation on both on the current workload and the predicted workload.

The network dispatcher 220 uses various criteria such as, for example, a load-balancing algorithm to route the requests of clients 35 to one of a set of processing nodes in the server cluster 40. Under moderate load conditions, the local domain 50 can provide clients 35 with service levels that satisfy the previously negotiated service-level agreements 230 using only its set of node resources in the server cluster 40.

It is to be understood that the specific embodiments of the invention that have been described are merely illustrative of certain applications of the principle of the present invention. Numerous modifications may be made to the system, method, and service for supporting transaction and parallel services on clustered systems based on service level agreements described herein without departing from the spirit and scope of the present invention.

1. A method for supporting a transaction application and a parallel application in a clustered system that utilizes a service level agreement, the method comprising:
monitoring a performance of the clustered system in response to the transaction application, based on the service level agreement and a workload of the clustered system;
analyzing the performance of the clustered system to identify a violation of the service level agreement, if any, by the clustered system; and
in response to the identified violation, dynamically reallocating a computing resource assigned to the parallel application to the transaction application that requires an additional computing resource to meet the service level agreement.

2. The method of claim 1, wherein the parallel application comprises a numerically intensive application.

3. The method of claim 1, wherein the transaction application comprises a plurality of discrete events that are less numerically intensive than the parallel application.

4. The method of claim 1, wherein the clustered system comprises a cluster of computers that process the transaction application and the parallel application.

5. The method of claim 1, wherein the service level agreement defines an acceptable performance of the clustered system in response to the transaction application.

6. The method of claim 1, wherein the service level agreement defines an acceptable performance of the clustered system in response to the parallel application.

7. The method of claim 1, wherein the violation comprises an actual violation of the service level agreement by the performance of the clustered system.

8. The method of claim 1, further comprising making a prediction of the performance of the clustered system to identify a potential violation of the service level agreement, if any, by the performance of the clustered system.

9. The method of claim 8, wherein the violation comprises a predicted violation of the service level agreement by the performance of the clustered system.

10. The method of claim 9, wherein the computing resource comprises an under-utilized computing resource.

11. The method of claim 1, further comprising provisioning the computing resource to execute the transaction application.

12. The method of claim 1, further comprising provisioning the computing resource to execute the parallel application.

13. The method of claim 11, further comprising diverting a portion of the workload to the computing resource.

14. A computer program product having instruction codes for supporting a transaction application and a parallel application in a clustered system that utilizes a service level agreement, the computer program product comprising:
a first set of instruction codes for monitoring a performance of the clustered system in response to the transaction application, based on the service level agreement and a workload of the clustered system;
a second set of instruction codes for analyzing the performance of the clustered system to identify a violation of the service level agreement, if any, by the clustered system; and
a third set of instruction codes, which, in response to the identified violation, dynamically reallocates a computing resource from the parallel application to the transaction application that requires an additional computing resource to meet the service level agreement.

15. The computer program product of claim 14, wherein the parallel application comprises a numerically intensive application.

16. The computer program product of claim 14, wherein the transaction application comprises a plurality of small discrete events that are not numerically intensive.

17. The computer program product of claim 14, wherein the service level agreement defines an acceptable performance of the clustered system in response to the transaction application.

18. The computer program product of claim 14, wherein the service level agreement defines an acceptable performance of the clustered system in response to the parallel application.

19. The computer program product of claim 14, wherein the violation comprises an actual violation of the service level agreement by the performance of the clustered system.

20. The computer program product of claim 14, further comprising a fourth set of instruction codes for making a prediction of the performance of the clustered system to identify a potential violation of the service level agreement, if any, by the performance of the clustered system.

21. The computer program product of claim 20, wherein the violation comprises a predicted violation of the service level agreement by the performance of the clustered system.

22. The computer program product of claim 14, further comprising a fifth set of instruction codes for provisioning the computing resource to execute the transaction application.

23. The computer program product of claim 14, further comprising a sixth set of instruction codes for provisioning the computing resource to execute the parallel application.

24. A system for supporting a transaction application and a parallel application in a clustered system that utilizes a service level agreement, the system comprising:
a server allocation controller monitors a performance of the clustered system in response to the transaction application, based on the service level agreement and a workload of the clustered system;
a service level agreement monitor analyzes the performance of the clustered system to identify a violation of the service level agreement, if any, by the clustered system; and
a server allocation manager which, in response to the identified violation, dynamically reallocates a computing resource from the parallel application to the transaction application that requires an additional computing resource to meet the service level agreement.

25. The system of claim 24, wherein the parallel application comprises a numerically intensive application.

26. The system of claim 24, wherein the transaction application comprises a plurality of small discrete events that are not numerically intensive.

27. The system of claim 24, wherein the clustered system comprises a cluster of computers that process the transaction application and the parallel application.

28. The system of claim 24, wherein the service level agreement defines an acceptable performance of the clustered system in response to the transaction application.

29. The system of claim 24, wherein the service level agreement defines an acceptable performance of the clustered system in response to the parallel application.

30. The system of claim 24, wherein the violation comprises an actual violation of the service level agreement by the performance of the clustered system.

31. A method for supporting a transaction application and a parallel application by a clustered system that implements a service level agreement, the method comprising:
specifying a performance parameter for the service level agreement;
invoking a server allocation utility, wherein the performance parameter is made available to the server allocation utility for allocating computing resources to meet the service level agreement; and
receiving a level of performance by the clustered system within the parameter of the service level agreement for a contracted execution of the transaction application and the parallel application, wherein in response to a violation of the service level agreement, the server allocation utility dynamically reallocates a computing resource that is assigned to the parallel application, to the transaction application that requires an additional computing resource.

32. The method of claim 31, wherein the violation comprises an actual violation of the service level agreement by the performance of the clustered system.

33. The method of claim 32, wherein the violation comprises a predicted violation of the service level agreement by the performance of the clustered system.
